(19) United States
(12) Patent Application Publication
(10) Pub. No.: US 2025/0209685 A1
(43) Pub. Date: Jun. 26, 2025

(54) IMAGE PROCESSING APPARATUS FOR PERFORMING REPROJECTION PROCESSING FOR REDUCING CG IMAGE DELAY AND CONTROL METHOD FOR IMAGE PROCESSING APPARATUS

(71) Applicant: CANON KABUSHIKI KAISHA, Tokyo (JP)

(72) Inventor: HIKARU UCHIDATE, Kanagawa (JP)

(21) Appl. No.: 18/982,236

(22) Filed: Dec. 16, 2024

(30) Foreign Application Priority Data
Dec. 25, 2023 (JP) 2023-218311

(51) Int. Cl. G06T 11/00

(52) U.S. Cl. CPC G06T 11/00

(57) ABSTRACT

An image processing apparatus includes one or more processors and/or circuitry configured to: acquire information about position and orientation of a display apparatus; acquire information about relative position and orientation of a mobile object, which moves independently of the display apparatus, with respect to the display apparatus; perform rendering processing to render a first object arranged in real space based on position and orientation of the display apparatus and to render a second object arranged in the real space based on position and orientation of the mobile object; and perform reprojection processing on the first object based on a change in position and orientation of the display apparatus during the rendering processing and perform reprojection processing on the second object based on a change in relative position and orientation of the mobile object with respect to the display apparatus during the rendering processing.

### BACKGROUND OF THE INVENTION

### Field of the Invention

The present invention relates to an image processing apparatus for performing reprojection processing for reducing CG image delay, and a control method for an image processing apparatus.

### Description of the Related Art

In recent years, mixed reality (MR) technology has been known as a technology for seamlessly integrating a real world and a virtual world in real time. MR technology is realized by using, for example, video see-through head mounted displays (HMDs). A video see-through HMD captures an image of a subject observed from the pupil position of a user wearing the HMD by a video camera or the like and allows the user to observe a mixed reality image in which computer graphics (CG) are superimposed on the captured image.

In an MR system, information about the position and orientation of an HMD in the space experienced by the user wearing the HMD can be acquired by using a plurality of cameras and various sensors, etc. Further, when the user holds a mobile object that moves independently of the HMD, information about the position of the mobile object can be acquired by capturing an image of the mobile object by a camera mounted on the HMD. By rendering CG based on the information about the position of the mobile object, the user can experience the MR including the CG that move independently of the HMD.

Generally, a video image that the user experiences by wearing the HMD develops a delay in a CG image, and this could cause the user to have motion sickness. Therefore, in order to cancel the delay in the CG image, the HMD performs reprojection processing in accordance with a change in its position and orientation. Japanese Translation of PCT Application No. 2019-506015 and WO 2019/229816 disclose a technique for improving the video latency (Motion-to-Photon Latency) that occurs until the CG is displayed based on the movement of the HMD.

However, the CG corresponding to the mobile object that moves independently of the HMD stops following the mobile object when the reprojection processing is performed in accordance with a change in position and orientation of the HMD. If the CG corresponding to the mobile object is not appropriately reprojected, the user may feel a sense of discomfort.

### SUMMARY OF THE INVENTION

The present invention provides an image processing apparatus that achieves reprojection processing without causing a sense of discomfort for the CG following a mobile object that moves independently of an HMD.

A first aspect of the present invention is an image processing apparatus including one or more processors and/or circuitry configured to: perform first acquisition processing to acquire information about position and orientation of a display apparatus; perform second acquisition processing to acquire information about relative position and orientation of a mobile object, which moves independently of the display apparatus, with respect to the display apparatus; perform rendering processing to render a first object arranged in real space, which serves as a field of view of a user, based on position and orientation of the display apparatus and to render a second object arranged in the real space based on position and orientation of the mobile object; and perform reprojection processing on the first object based on a change in position and orientation of the display apparatus during the rendering processing and perform reprojection processing on the second object based on a change in relative position and orientation of the mobile object with respect to the display apparatus during the rendering processing.

A second aspect of the present invention is a control method for an image processing apparatus, the control method including the steps of: acquiring information about position and orientation of a display apparatus; acquiring information about relative position and orientation of a mobile object, which moves independently of the display apparatus, with respect to the display apparatus; performing rendering processing to render a first object arranged in real space, which serves as a field of view of a user, based on position and orientation of the display apparatus and to render a second object arranged in the real space based on position and orientation of the mobile object; and performing reprojection processing on the first object based on a change in position and orientation of the display apparatus during the rendering processing and performing reprojection processing on the second object based on a change in relative position and orientation of the mobile object with respect to the display apparatus during the rendering processing.

A third aspect of the present invention is a non-transitory computer-readable medium that stores a program, wherein the program causes a computer to execute a control method for an image processing apparatus, the control method including the steps of: acquiring information about position and orientation of a display apparatus; acquiring information about relative position and orientation of a mobile object, which moves independently of the display apparatus, with respect to the display apparatus; performing rendering processing to render a first object arranged in real space, which serves as a field of view of a user, based on position and orientation of the display apparatus and to render a second object arranged in the real space based on position and orientation of the mobile object; and performing reprojection processing on the first object based on a change in position and orientation of the display apparatus during the rendering processing and performing reprojection processing on the second object based on a change in relative position and orientation of the mobile object with respect to the display apparatus during the rendering processing.

Further features of the present invention will become apparent from the following description of exemplary embodiments with reference to the attached drawings.

### BRIEF DESCRIPTION OF THE DRAWINGS

FIG. 1 is a configuration diagram schematically illustrating a system including an HMD and an image processing apparatus;

FIG. 2 is a block diagram illustrating functional configurations of the HMD and the image processing apparatus;

FIGS. 3A to 3C are diagrams illustrating an example of combining a camera image and a CG image;

FIGS. 4A to 4C are diagrams illustrating an example of combining a camera image and a CG image;

FIG. 5 is a block diagram illustrating an HMD and an image processing apparatus according to Embodiment 1;

FIG. 6 is a flowchart illustrating an example of reprojection processing;

FIGS. 7A to 7C are diagrams illustrating an example of combining a camera image and a CG image according to Embodiment 1;

FIG. 8 is a block diagram illustrating an HMD and an image processing apparatus according to Embodiment 2;

FIG. 9 is a block diagram illustrating an HMD and an image processing apparatus according to Embodiment 3; and

FIGS. 10A to 10C are diagrams illustrating an example of combining a camera image and a CG image according to Embodiment 3.

### DESCRIPTION OF THE EMBODIMENTS

### Embodiment 1

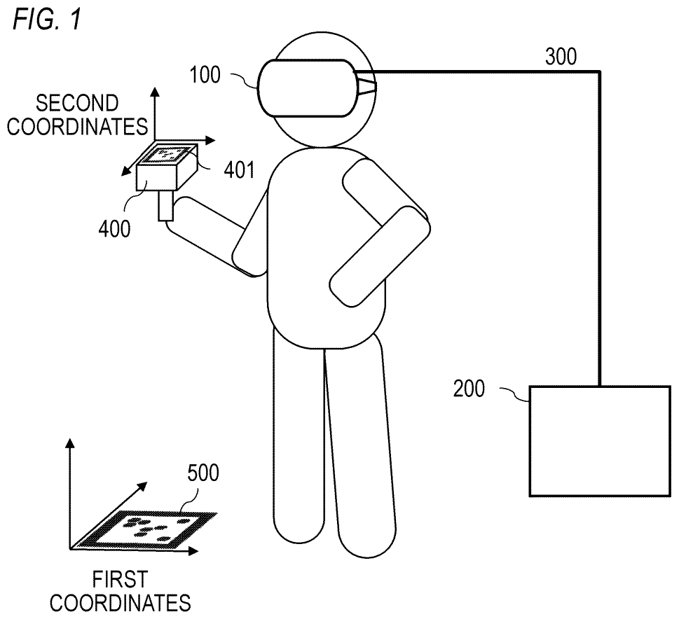

Hereinafter, embodiments of the present invention will be described with reference to the drawings. FIG. 1 is a configuration diagram schematically illustrating a system including an HMD 100 and an image processing apparatus.

In an example in FIG. 1, a head mounted display (HMD) 100 is connected to an image processing apparatus 200. The HMD 100 is worn on the head of a user. The HMD 100 displays mixed reality images on a display so that the user can experience mixed reality. The image processing apparatus 200 generates images to be displayed on the HMD 100.

An interface 300 connects the HMD 100 and the image processing apparatus 200 with a wired cable. The HMD 100 and the image processing apparatus 200 mutually transmit and receive data via the interface 300. The data transmitted and received is not limited to image data, and may include sensing data output from an acceleration sensor and an angular velocity sensor, audio data, control data for controlling the HMD 100, etc. The interface 300 may use a wired connection or may use a wireless connection.

The HMD 100 captures an image of real space with a camera (image capturing apparatus) disposed facing outward. The HMD 100 displays, on a display, a mixed reality image obtained by combining a captured camera image and a CG image. The image processing apparatus 200 calculates a position for rendering the CG from a camera image (captured image) and sensing data, and performs CG rendering processing. In order to obtain the CG rendering position, a marker 500 is placed, for example, on a floor in the real world. The image processing apparatus 200 detects a marker position whose coordinates are known from the camera image, and generates CG (hereinafter, referred to as world coordinate CG) corresponding to first coordinates uniquely determined with reference to the marker 500. That is, the world coordinate CG are CG (a first object) arranged in the real space, which serves as the field of view of the user, based on the position and orientation of the HMD 100. The image processing apparatus 200 generates a mixed reality image by combining the world coordinate CG and the camera image.

In addition, in order to provide a more realistic virtual experience, the image processing apparatus 200 may generate CG (hereinafter, referred to as target coordinate CG) positioned in accordance with, for example, the movement of an object 400 (hereinafter, referred to as mobile object 400) held by the user in his/her hand, separately from the world coordinate CG. The mobile object 400 moves independently of the HMD 100. The target coordinate CG are CG (a second object) arranged in the real space based on the position and orientation of the mobile object. The target coordinate CG correspond to second coordinates uniquely determined with reference to a marker 401 provided on the mobile object 400. The image processing apparatus 200 can generate a more complex mixed reality image by combining the world coordinate CG and the target coordinate CG.

An example of the image processing apparatus 200 is a personal computer (PC). The image processing apparatus 200 may be connected to an external server via a network. The image processing apparatus 200 may be a mobile apparatus that can be carried with the HMD 100. The image processing apparatus 200 may be an apparatus incorporated in the HMD 100.

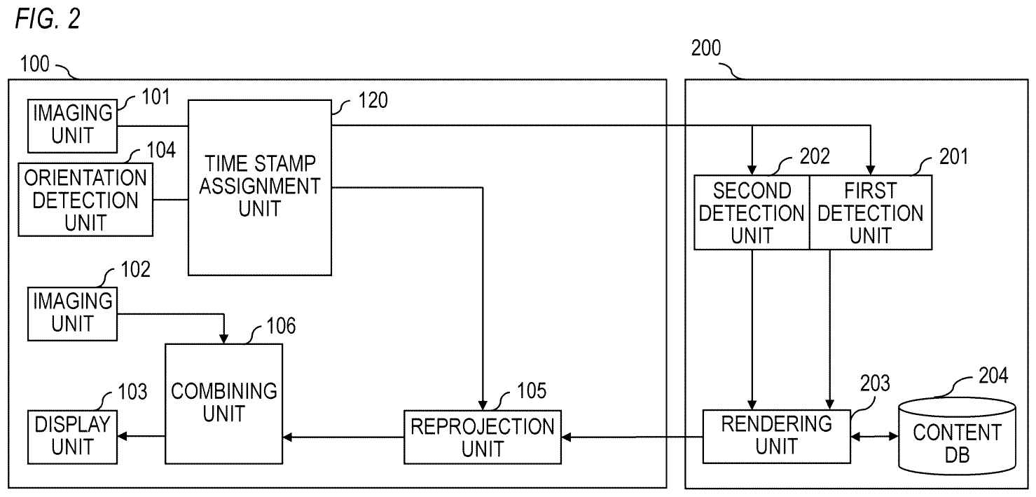

(Reprojection Processing Based on Change in Position and Orientation of HMD 100) FIG. 2 is a block diagram illustrating an example of functional configurations of the HMD 100 and the image processing apparatus 200. Some of the functions of the HMD 100 illustrated in FIG. 2 may be implemented by the image processing apparatus 200. A part of the image processing apparatus 200 may be implemented by the HMD 100.

The HMD 100 includes an imaging unit 101, an imaging unit 102, a display unit 103, an orientation detection unit 104, a reprojection unit 105, a combining unit 106, and a time stamp assignment unit 120. The imaging unit 101 and the imaging unit 102 capture images of the outside world (the real space serving as the field of view of the user). The display unit 103 controls display of a mixed reality image to the user. The orientation detection unit 104 detects the position and orientation of the HMD 100.

The time stamp assignment unit 120 issues a time stamp of the timing at which the imaging unit 101 has captured a camera image, and assigns the issued time stamp to the captured camera image. The time stamp assignment unit 120 issues a time stamp of the timing at which the orientation detection unit 104 has acquired the position and orientation information about the HMD 100, and assigns the issued time stamp to the acquired position and orientation information.

The reprojection unit 105 performs reprojection processing of the CG image based on the sensing data of the orientation detection unit 104. The combining unit 106 generates a combined image by combining the image of the real space captured by the imaging unit 102, which serves as the field of view of the user, and the CG image on which the reprojection processing has been performed by the reprojection unit 105. The generated combined image is displayed on the display unit 103.

The orientation detection unit 104 detects position information and orientation information, such as a rotation angle and tilt, of the HMD 100. The orientation detection unit 104 is realized by appropriately combining an acceleration sensor, an angular velocity sensor, a geomagnetic sensor, and the like. The orientation detection unit 104 may sense the movement of the HMD 100 in real time.

The image processing apparatus 200 includes a first detection unit 201, a second detection unit 202, a rendering unit 203, and a content DB 204. The first detection unit 201 detects first coordinates for rendering world coordinate CG from a camera image captured by the imaging unit 101. The second detection unit 202 detects second coordinates for rendering target coordinate CG from a camera image captured by the imaging unit 101.

The rendering unit 203 reads CG (content) data from the content DB 204 and renders CG. The rendering unit 203 renders world coordinate CG with reference to the coordinate position of the first coordinates and renders target coordinate CG with reference to the coordinate position of the second coordinates.

There are a plurality of algorithms used for CG rendering, and the rendering unit 203 can use, for example, a polygon-unit calculation method (hereinafter, referred to as polygon rendering) widely used in a field called real-time rendering. The polygon rendering process is executed by a rendering engine, which is a known technique, and thus, detailed description thereof will be omitted.

A certain amount of processing time is required for performing a series of processes in which the imaging unit 101 captures a camera image, the rendering unit 203 performs CG rendering processing, and the rendered CG image is output to the HMD 100. When the refresh rate of the display apparatus is 60 Hz and the screen is updated at 60 fps (frames/second), even if the processing performance of the image processing apparatus 200 is sufficiently high, latency (delay) of at least one frame is developed. When the frame rate is 60 fps, the latency is around 16.67 ms. The latency occurs due to various factors such as the processing performance of the image processing apparatus 200, the refresh rate of the display apparatus, the resolution of the camera image, and the data volume of CG (contents).

When the head of the user using the HMD 100 has moved, a camera image is combined with a CG image generated with a delay based on the past position and orientation of the HMD 100. When a mixed reality image obtained by combining the CG image generated with a delay and the camera image is displayed, the user not only recognizes the misalignment between the CG image and the camera image but may also suffer from motion sickness.

Therefore, in order to reduce the misalignment recognized by the user, the reprojection unit 105 performs reprojection processing of the generated CG image. Although it is possible for the image processing apparatus 200 to predict the position and orientation information about the HMD 100 and perform rendering, in Embodiment 1, the reprojection unit 105 performs reprojection processing by using the latest sensing result obtained by detecting the position and orientation of the HMD 100 so as to reduce the delay.

To perform the reprojection processing for reducing the delay of the CG image, the reprojection unit 105 acquires position and orientation information about the HMD 100 before and after the CG image is output to the combining unit 106. The reprojection unit 105 acquires the position and orientation information about the HMD 100 before and after the CG image is output to the combining unit 106 based on information about the time stamps assigned to the camera image and the position and orientation information about the HMD 100.

Specifically, the time stamp assignment unit 120 issues time stamps when the imaging unit 101 acquires a camera image and when the orientation detection unit 104 acquires position and orientation information about the HMD 100. The time stamp is issued in synchronization with each image frame of the camera image, and is assigned to each image frame as time information. Similarly, the time stamp is issued in synchronization with each sampling timing of the data of position and orientation information about the HMD 100, and is assigned to the position and orientation information as time information.

The reprojection unit 105 holds the latest position and orientation information and the position and orientation information corresponding to a plurality of past time stamps. The rendering unit 203 of the image processing apparatus 200 assigns the information about the time stamp assigned to the camera image acquired from the HMD 100 to the generated CG image, and outputs the CG image to the reprojection unit 105. The reprojection unit 105 can accurately acquire a change in position and orientation caused by a delay time due to the generation of the CG image based on the past position and orientation information corresponding to the time stamp assigned to the CG image and the latest position and orientation information.

The reprojection unit 105 obtains a difference between the position and orientation of the HMD 100 when the camera image is captured by the imaging unit 101 and the latest position and orientation of the HMD 100 when the CG image is output from the rendering unit 203. The reprojection unit 105 corrects (reprojects) the CG image in accordance with the movement of the user of the HMD 100. The reprojection unit 105 can correct the CG image by, for example, homography transformation.

The combining unit 106 combines the CG image on which the reprojection processing has been performed and the latest camera image captured by the imaging unit 101. The combining unit 106 can generate a mixed reality image in which the user does not recognize the delay of the CG image by performing the reprojection processing of the CG image based on the change in the position and orientation caused by the delay time (rendering processing time) due to the generation of the CG image.

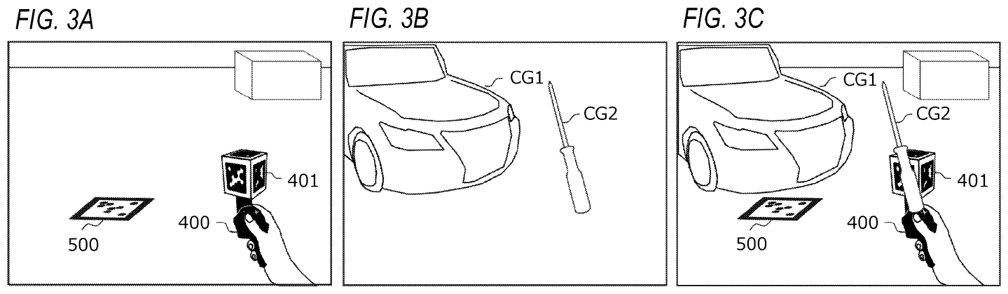

FIGS. 3A to 3C illustrate an example of detecting, from a camera image captured by the imaging unit 101, coordinate positions serving as references for rendering CG. The method for specifying the coordinate position in the real space is not limited to this example. The coordinate position of the HMD 100 in the real space may be specified by using the reflection of infrared light emitted from an external sensor.

The method for acquiring the position and orientation information about the HMD 100 is not limited to the inside-out method in which the position and orientation information is acquired from a camera image captured by the imaging unit 101 of the HMD 100. The position and orientation information about the HMD 100 may also be acquired by an outside-in method. The outside-in method is a method in which the position and orientation information about the HMD 100 is acquired by tracking a reflective material or the like provided on the HMD 100 by a camera or sensors installed outside. The position and orientation information about the HMD 100 may be measured by using inertial sensors such as a gyro sensor and an acceleration sensor.

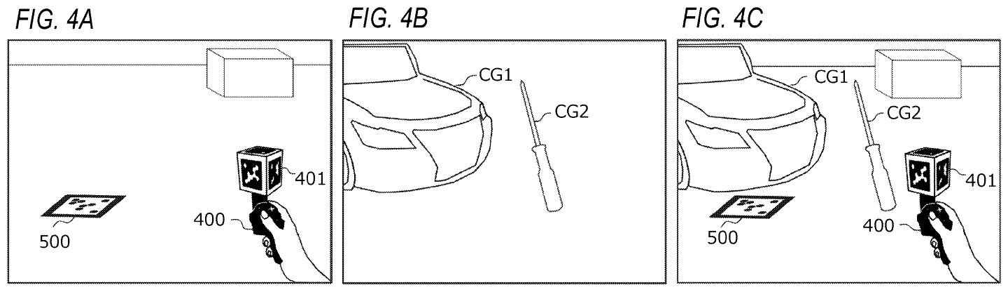

(Combining Camera Image and CG Image) An example of combining a camera image and a CG image will be described with reference to FIGS. 3A to 3C and FIGS. 4A to 4C. FIGS. 3A to 3C illustrate an example of a case where the user is stationary and reprojection processing is not performed. FIGS. 4A to 4C illustrate an example of a case where the reprojection processing is performed in accordance with the movement of the user.

FIG. 3A illustrates an example of a real space image viewed by the user using the HMD 100. The image in FIG. 3A is an example of an image obtained by displaying a real space image captured by a camera attached to the HMD 100, facing outward, without superimposing CG. In the real space, a marker 500 serving as a reference for superimposing world coordinate CG is placed on the floor. The user holds, in the right hand, a mobile object 400 on which a marker 401 serving as a reference for superimposing target coordinate CG is provided. FIG. 3A is an image of the real space, which serves as the field of view of the user, and illustrates a state in which the marker 500 and the mobile object 400 held by the user are displayed.

FIG. 3B illustrates a CG image in which the image processing apparatus 200 has rendered CG from the camera image in FIG. 3A. CG 1 of a vehicle is rendered with reference to the position of the marker 500, which is used for superimposing world coordinate CG. CG 2 of a screwdriver is rendered with reference to the position of the marker 401, which is used for superimposing target coordinate CG. The CG image in which the CG 1 and the CG 2 are rendered is output to the reprojection unit 105 of the HMD 100.

FIG. 3C is a combined image obtained by combining the camera image in FIG. 3A and the CG image in FIG. 3B. The CG1 of the vehicle is superimposed on the camera image with reference to the position of the marker 500. The CG2 of the screwdriver is superimposed on the camera image with reference to the position of the marker 401. The combined image illustrated in FIG. 3C is displayed on the display unit 103 of the HMD 100. In the example in FIG. 3C, the user using the HMD 100 is stationary, and image correction by reprojection processing is not performed. When the user is stationary, the CG 1 of the vehicle and the CG 2 of the screwdriver are rendered at the desired positions, and a sense of discomfort caused by the misalignment between the CG and the captured real space image does not occur.

FIGS. 4A to 4C are diagrams illustrating an example of combining a camera image and a CG image in a case where reprojection processing is performed by the configuration of the HMD 100 and the image processing apparatus 200 illustrated in FIG. 2. FIG. 4A illustrates a real space image captured by the imaging unit 102 of the HMD 100 in a state in which the user turns his/her head to the right from the state in FIG. 3A. The user turns his/her head to the right and moves his/her right hand to the right. That is, in FIG. 4A, the marker 500 and the real space image appear to have moved to the left, which is the opposite direction to the movement of the head, with respect to the real space image in FIG. 3A. On the other hand, the right hand and the mobile object 400 are independent of the movement of the head, and therefore move differently from the movement of the head.

The image processed by the image processing apparatus 200 is the camera image illustrated in FIG. 3A before the user moves the head. That is, the image processing apparatus 200 generates a CG image based on the camera image in FIG. 3A captured at the time when the user has started the movement. The CG image output from the image processing apparatus 200 is the image illustrated in FIG. 3B. If the reprojection processing is not performed, a misalignment develops between the camera image and the CG image due to the movement of the head during the time (delay time) for generating the CG image. Thus, the reprojection unit 105 performs reprojection processing on the CG image in FIG. 3B.

As illustrated in FIG. 2, the reprojection unit 105 acquires the latest position and orientation information about the HMD 100 from the orientation detection unit 104. As described with reference to FIG. 4A, even when the user moves his/her head, the orientation detection unit 104 can sense the state of the HMD 100 in real time and acquire information about the position and orientation, etc.

The reprojection unit 105 performs image transformation such that the delay of the CG image is canceled based on the sensing information acquired in real time. Specifically, when the user turns his/her head to the right, the image transformation is performed such that the CG are moved to the opposite direction, that is, to the left. FIG. 4B illustrates a CG image obtained by performing image transformation on the image illustrated in FIG. 3B by the reprojection unit 105. In FIG. 4B, the CG 1 of the vehicle and the CG 2 of the screwdriver have moved to the direction that cancels the movement of the head of the user.

FIG. 4C is a combined image obtained by combining the camera image in FIG. 4A and the CG image in FIG. 4B. Since the reprojection processing has been performed on the CG image in FIG. 4B in accordance with the movement of the head of the user, the CG 1 of the vehicle is superimposed on the camera image such that the CG 1 of the vehicle follows the marker 500. On the other hand, the CG 2 of the screwdriver fails to follow the marker 401, and is superimposed on the camera image at a position misaligned from the mobile object 400 held by the right hand of the user. The misalignment between the CG 2 of the screwdriver and the mobile object 400 has occurred because the mobile object 400 moves independently of the HMD 100.

(Combining Camera Image, World Coordinate CG Image, and Target Coordinate CG Image) The combined image in which the CG 2 of the screwdriver and the mobile object 400 are misaligned gives the user a sense of discomfort. Thus, the HMD 100 performs the reprojection processing on the CG 2 of the screwdriver, which is the target coordinate CG, separately from the CG 1 of the vehicle, which is the world coordinate CG. Specifically, the HMD 100 performs the reprojection processing on the CG 1 of the vehicle based on a change (movement) in the position and orientation of the HMD 100 during the rendering processing. Further, the HMD 100 performs the reprojection processing on the CG 2 of the screwdriver based on a change in the relative position and orientation (movement) of the mobile object 400 with respect to the HMD 100 during the rendering processing. The HMD 100 generates a combined image by combining the CG 1 of the vehicle and the CG 2 of the screwdriver on which the reprojection processing have separately been performed.

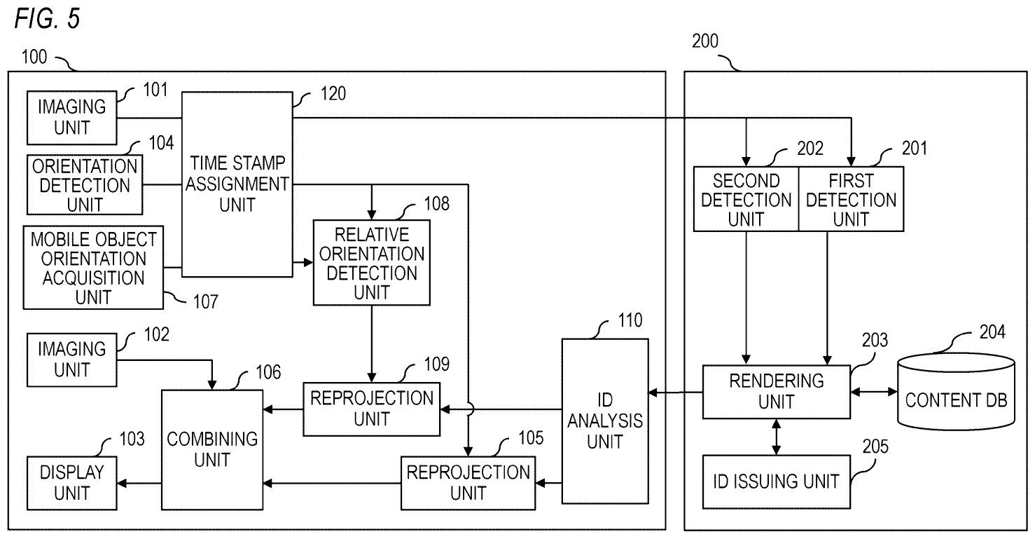

A configuration of the HMD 100 and the image processing apparatus 200 for separately performing the reprojection processing on the world coordinate CG and the target coordinate CG will be described with reference to FIG. 5. FIG. 5 is a block diagram illustrating an HMD 100 and an image processing apparatus 200 according to Embodiment 1. Some of the functions of the HMD 100 illustrated in FIG. 5 may be implemented by the image processing apparatus 200. A part of the image processing apparatus 200 may be implemented by the HMD 100.

In addition to the configuration described with reference to FIG. 2, the HMD 100 includes a mobile object orientation acquisition unit 107, a relative orientation detection unit 108, a reprojection unit 109, and an ID analysis unit 110. In addition to the configuration described with reference to FIG. 2, the image processing apparatus 200 includes an ID issuing unit 205. The same reference numerals are given to the same components as those in FIG. 2, and detailed description thereof will be omitted.

The mobile object orientation acquisition unit 107 acquires position and orientation information about the mobile object 400. The relative orientation detection unit 108 acquires relative position and orientation information about the mobile object 400 with respect to the HMD 100. The reprojection unit 109 performs reprojection processing of the CG that follow the mobile object 400 based on the detection result of the relative orientation detection unit 108. The ID analysis unit 110 analyzes IDs issued by the ID issuing unit 205 of the image processing apparatus 200. The ID issuing unit 205 issues mutually distinguishable IDs to each of the world coordinate CG and the target coordinate CG.

The mobile object 400 has an orientation detection unit, and transmits the latest position and orientation information to the HMD 100. The orientation detection unit of the mobile object 400 may be realized by appropriately combining an acceleration sensor, an angular velocity sensor, a geomagnetic sensor, and the like, similarly to the orientation detection unit 104 of the HMD 100. The position and orientation information about the mobile object 400 may be detected by a method such as motion tracking in which a reflective material that reflects infrared light is attached to the mobile object 400, and the position and orientation of the mobile object 400 is detected from the reflection of the infrared light emitted from an external sensor.

The detected position and orientation information is transmitted to the HMD 100 by wireless communication such as Bluetooth (registered trademark). The mobile object orientation acquisition unit 107 outputs the received position and orientation information about the mobile object 400 to the relative orientation detection unit 108.

At this time, the orientation detection unit 104 outputs the position and orientation information about the HMD 100 to the relative orientation detection unit 108. The relative orientation detection unit 108 detects information about the relative position and orientation of the movement of the HMD 100 and the movement of the mobile object 400 based on the position and orientation information about the HMD 100 and the position and orientation information about the mobile object 400.

A rendering unit 203 renders CG based on first coordinates and second coordinates detected by a first detection unit 201 and a second detection unit 202, and CG data read from a content DB 204.

The first coordinates are, for example, coordinates in a coordinate system with reference to the marker 500 illustrated in FIG. 1. The world coordinate CG are rendered based on the coordinate system of the first coordinates. The second coordinates are, for example, coordinates in a coordinate system with reference to the marker 401 illustrated in FIG. 1. The target coordinate CG are rendered based on the coordinate system of the second coordinates.

The rendering unit 203 assigns an ID to each of the world coordinate CG and the target coordinate CG. For example, the rendering unit 203 associates the information about the IDs with the pixel positions where the world coordinate CG and the target coordinate CG are rendered. The rendering unit 203 acquires the ID corresponding to each of the world coordinate CG and the target coordinate CG from the ID issuing unit 205. For example, the world coordinate CG are associated with ID=1, and the target coordinate CG are associated with ID=2. The world coordinate CG and the target coordinate CG are mutually identifiable by their IDs.

The image data after the CG have been rendered is, for example, RGBA data in which color information and transparency information is provided for each excel of the image. Each of a plurality of channels (planes) included in the RGBA data is represented by 8 bits, 256 levels of numerical values. The R channel stores a luminance value of red, the G channel stores a luminance value of green, the B channel stores a luminance value of blue, and the A channel stores information about a ratio of transmittance (transparency).

The rendering unit 203 replaces, for example, 1 bit of the 8 bits of the A channel with the ID information. That is, the A channel represents the ratio of the transmittance with 7 bits of the 8-bit data and represents the ID information corresponding to the CG with 1 bit. The rendering unit 203 can output the RGBA data including the ID information by storing the ID in a part of the A channel including the information about the transmittance among the plurality of channels.

The method for associating the ID information with each pixel is not limited to the method in which the ID information corresponding to the CG is assigned to one bit of the plane A in the RGBA signal output from the rendering unit 203. For example, the ID information may be assigned to multiple bits and may include ID information about a plurality of CG (contents). The ID information may be assigned to a part of any of the RGB channels representing the color information. A new channel (plane) representing the ID information may be added. That is, the rendering unit 203 may associate the ID information with each pixel by any method as long as the ID information about the rendered CG can be specified.

The ID analysis unit 110 receives RGBA data including the ID information as CG image data from the image processing apparatus 200. The ID analysis unit 110 separates the CG image by ID embedded in each pixel. In the following description, it is assumed that ID corresponding to the world coordinate CG is 1 and ID corresponding to the target coordinate CG is 2.

The world coordinate CG are subjected to reprojection processing by the reprojection unit 105 in accordance with the latest position and orientation of the HMD 100. Therefore, the pixel data to which ID=1 is assigned is output to the reprojection unit 105. The target coordinate CG are subjected to reprojection processing by the reprojection unit 109 in accordance with the latest relative position and orientation of the mobile object 400 with respect to the HMD 100. Therefore, the pixel data to which ID=2 is assigned is output to the reprojection unit 109.

The reprojection unit 105 performs reprojection processing on the input CG image based on the latest position and orientation information about the HMD 100 acquired by the orientation detection unit 104. The reprojection unit 105 performs CG image transformation such that the delay in the world coordinate CG image that does not follow the movement of the HMD 100 is canceled by performing reprojection processing based on the latest position and orientation information about the HMD 100.

The reprojection unit 109 performs reprojection processing on the input CG image based on the latest relative position and orientation information about the mobile object 400 acquired by the relative orientation detection unit 108 and the position and orientation of the HMD 100. Since the relative orientation detection unit 108 can acquire the relative position and orientation of the mobile object 400 with respect to the HMD 100, the movement of the mobile object 400 that is not detected only by the position and orientation information about the HMD 100 acquired by the orientation detection unit 104 can also be taken into account.

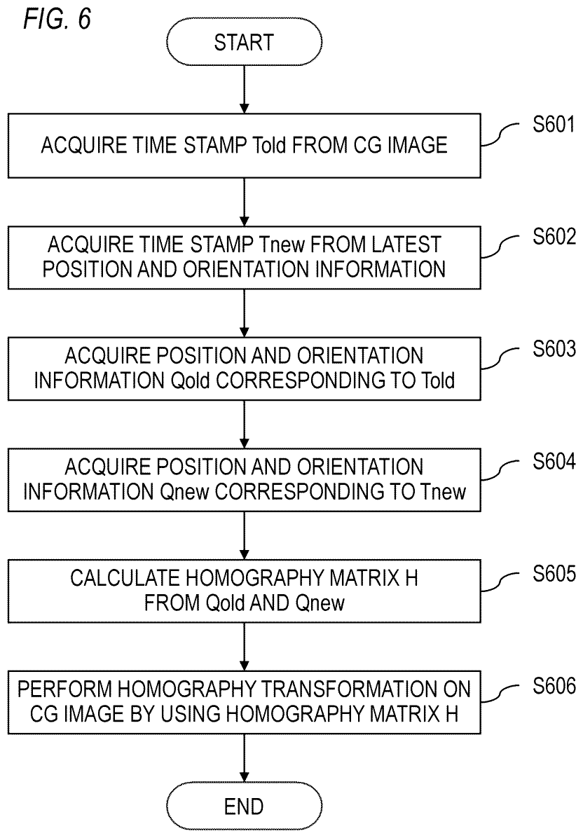

FIG. 6 is a flowchart illustrating an example of reprojection processing. Operations of the reprojection unit 105 and the reprojection unit 109 will be described with reference to the flowchart illustrated in FIG. 6. The reprojection unit 105 acquires the position and orientation information about the HMD 100 from the orientation detection unit 104. Whereas, the reprojection unit 109 acquires the relative position and orientation information about the mobile object 400 with respect to the HMD 100 from the relative orientation detection unit 108. The flow of the reprojection processing by the reprojection unit 109 is similar to the flow of the reprojection processing by the reprojection unit 105. Therefore, in FIG. 6, the reprojection processing by the reprojection unit 105 will be described. The reprojection processing by the reprojection unit 109 will be described by replacing the reprojection unit 105 with the reprojection unit 109 in the description of FIG. 6. In this case, the position and orientation information about the HMD 100 will be replaced with the relative position and orientation information about the mobile object 400 with respect to the HMD 100.

In step S601, the reprojection unit 105 acquires information about a time stamp Told from a CG image input from the ID analysis unit 110. In step S602, the reprojection unit 105 acquires information about a time stamp Tnew from the latest position and orientation information about the HMD 100.

In step S603, based on the time stamp Told acquired from the CG image and the stored position and orientation information about the HMD 100 from the past, the reprojection unit 105 acquires position and orientation information Qold about the HMD 100 corresponding to the Told. The reprojection unit 105 may acquire, from among the past position and orientation information about the HMD 100, the position and orientation information to which a time stamp indicating a time closer to the time stamp Told is assigned, for example. Alternatively, the reprojection unit 105 may acquire the position and orientation information at the time of the Told by performing interpolation calculation using the position and orientation information to which the time stamps before and after the time stamp Told are assigned. In step S604, the reprojection unit 105 acquires position and orientation information Qnew corresponding to the Tnew from the latest position and orientation information about the HMD 100.

In step S605, the reprojection unit 105 obtains a change in the position and orientation of the HMD 100 over time from the position and orientation information Qold and the position and orientation information Qnew, and calculates a homography matrix H for canceling the change in the position and orientation. In step S606, the reprojection unit 105 performs homography transformation on the CG image input from the ID analysis unit 110 by using the calculated homography matrix H.

By the reprojection processing illustrated in FIG. 6, the world coordinate CG image that does not follow the movement of the HMD 100 and the target coordinate CG image that does not follow the movement of the mobile object 400 are transformed such that the respective delays are canceled. The combining unit 106 combines the real-space camera image captured by the imaging unit 102, the world coordinate CG image on which the reprojection processing has been performed by the reprojection unit 105, and the target coordinate CG image on which the reprojection processing has been performed by the reprojection unit 109. The display unit 103 displays the combined image combined by the combining unit 106.

Embodiment 1 is not limited to the MR system, in which a CG image is superimposed on a real space image as described with reference to FIG. 5, and may also be applied to a virtual reality (VR) system. In the VR system, the HMD combines the world coordinate CG image on which the reprojection processing has been performed by the reprojection unit 105 and the target coordinate CG image on which the reprojection processing has been performed by the reprojection unit 109, and displays the combined image on the display unit 103.

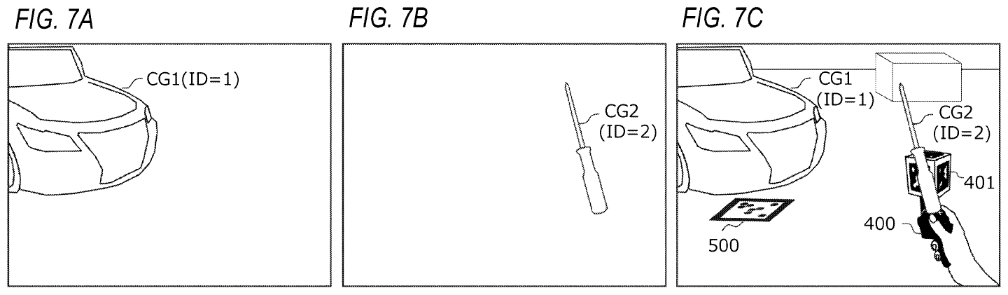

The effects of Embodiment 1 will be described with reference to FIGS. 3A to 3C, FIGS. 4A to 4C, and FIGS. 7A to 7C. FIGS. 7A to 7C are diagrams illustrating an example of combining the camera image in FIG. 4A and the CG image by the HMD 100 and the image processing apparatus 200 illustrated in FIG. 5. FIG. 4A illustrates the camera image after the user turns his/her head to the right. The CG image output by the rendering unit 203 is the image in FIG. 3B.

The ID analysis unit 110 separates image data by the ID assigned to the CG. The ID analysis unit 110 outputs the separated CG image as CG 1 (ID=1) to the reprojection unit 105, and outputs the separated CG image as CG 2 (ID=2) to the reprojection unit 109.

The reprojection unit 105 performs reprojection processing of the CG 1 of the vehicle based on the position and orientation of the HMD 100 acquired by the orientation detection unit 104. FIG. 7A illustrates an example of a CG image obtained after the reprojection unit 105 has performed the reprojection processing of the CG 1 of the vehicle. The CG 1 of the vehicle have moved to the direction that cancels the movement of the head of the user.

The reprojection unit 109 performs reprojection processing of the CG 2 of the screwdriver based on the position and orientation of the HMD 100 and the relative position and orientation of the mobile object 400 with respect to the HMD 100 acquired by the relative orientation detection unit 108. The relative orientation detection unit 108 acquires the relative position and orientation of the mobile object 400 with respect to the HMD 100. When the user wearing the HMD 100 turns his/her head to the right, the mobile object 400 held in the right hand moves to the right. In this case, the relative position and orientation of the mobile object 400 with respect to the HMD 100 also change. The reprojection unit 109 performs reprojection processing such that the change in the relative position and orientation of the mobile object 400 is canceled. FIG. 7B illustrates an example of a CG image obtained after the reprojection unit 109 has performed the reprojection processing of the CG 2 of the screwdriver. The CG 2 of the screwdriver has moved to follow the movement of the right hand with respect to the head of the user.

FIG. 7C illustrates a combined image obtained by combining the camera image in FIG. 4A, the world coordinate CG image in FIG. 7A, and the target coordinate CG image in FIG. 7B. Unlike the combined image illustrated in FIG. 4C, the CG 2 of the screwdriver follows the marker 401 and is superimposed on the position of the mobile object 400 in the camera image in FIG. 4A.

In Embodiment 1 described above, the HMD 100 includes the relative orientation detection unit 108 that detects the relative position and orientation of the mobile object 400 with respect to the HMD 100. The HMD 100 performs the reprojection processing on the target coordinate CG separately from the reprojection processing on the world coordinate CG based on the relative position and orientation information about the mobile object 400. As a result, the HMD 100 can appropriately reproject the target coordinate CG following the mobile object 400 that moves independently of the HMD 100.

While the example in which a single mobile object 400 that moves independently of the HMD 100 is used has been described, a plurality of mobile objects 400 may be used. When there is a plurality of mobile objects 400, the HMD 100 can perform the reprojection processing based on information about the relative positions and orientations of the respective mobile objects 400 by using the IDs corresponding to the respective mobile objects 400.

While the image transformation performed by the reprojection unit 105 has been described by using the example in which the image is shifted in parallel. However, the image transformation is not limited to the parallel translation. In addition to movements in forward, backward, left, right, up, and down directions, the movement of the user includes movements in roll, pitch, and yaw directions. Therefore, in accordance with the movement of the user, the reprojection unit 105 may perform keystone correction using a homography transformation matrix or perform image correction such as upscaling, downscaling, and rotating.

### Embodiment 2

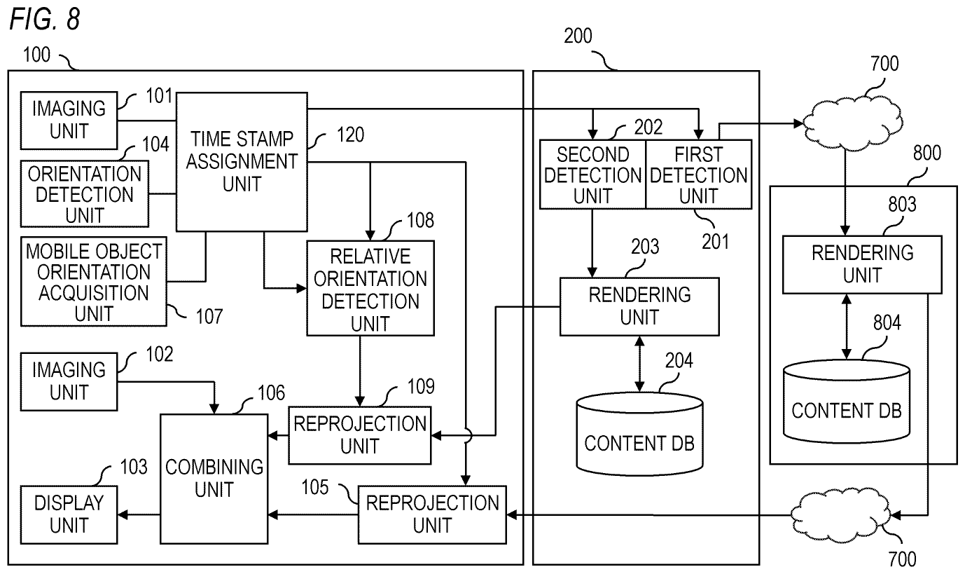

In Embodiment 2, a part of the rendering processing performed by the image processing apparatus 200 is performed by an external apparatus. FIG. 8 is a block diagram illustrating an HMD 100 and an image processing apparatus 200 according to Embodiment 2. The HMD 100 and the image processing apparatus 200 are connected to a server (external apparatus) 800 via a network 700. In Embodiment 2, the HMD 100 acquires a CG image by combining rendering by the image processing apparatus 200 (hereinafter, referred to as edge rendering) and rendering by the server 800 (hereinafter, referred to as cloud rendering). The server 800 can reduce the processing time of the high-load CG rendering. Some of the functions of the HMD 100 illustrated in FIG. 8 may be implemented by the image processing apparatus 200. A part of the image processing apparatus 200 may be implemented by the HMD 100.

In the cloud rendering, although a delay occurs due to communication via the network 700, it is possible to achieve CG rendering of high-load contents with a higher throughput compared to the edge rendering because the server 800 uses a plurality of high-performance devices in parallel. On the other hand, in the edge rendering, the performance of the CG rendering is dependent on the performance of the image processing apparatus 200, and it is difficult for the image processing apparatus 200 to achieve high-throughput rendering. However, since the image processing apparatus 200 does not use the network 700, the edge rendering can achieve lower latency compared to the cloud rendering.

Therefore, the HMD 100 uses the image processing apparatus 200 to perform the rendering processing on contents (for example, target coordinate CG) to be rendered with a low load, and uses the server 800 to perform the rendering processing on contents (for example, world coordinate CG) to be rendered with a high load.

A first detection unit 201 of the image processing apparatus 200 detects first coordinates for rendering world coordinate CG from a camera image. The first detection unit 201 transmits the detected first coordinates to the server 800 via the network 700. A rendering unit 803 of the server 800 reads CG (content) data to be displayed from a content DB 804 by using information about the received first coordinates and renders the CG. The rendering unit 803 transmits the rendered CG image to the image processing apparatus 200 via the network 700. The image processing apparatus 200 transmits the received CG image to a reprojection unit 105 without making any change. The rendering unit 803 may directly transmit the rendered CG image to the HMD 100 via the network 700.

As in Embodiment 1, a second detection unit 202 of the image processing apparatus 200 detects second coordinates for rendering target coordinate CG from a camera image. The rendering unit 203 of the image processing apparatus 200 renders the target coordinate CG. The rendering unit 203 transmits the rendered CG image to a reprojection unit 109 of the HMD 100.

Since the rendering processing time of the target coordinate CG image in the image processing apparatus 200 is different from the rendering processing time of the world coordinate CG image in the server 800, the delay times are not the same. However, since the time stamps are assigned to the camera images output to the image processing apparatus 200, even when the delay time varies for the individual CG, the HMD 100 (the reprojection unit 105 and the reprojection unit 109) can calculate the delay time more accurately.

Specifically, the HMD 100 can calculate the delay time for the individual CG by comparing the time stamp assigned to the rendered CG image with the time stamp assigned to the latest position and orientation data of HMD 100 or the mobile object 400. The time stamp assigned to the CG image is the same as the time stamp assigned to the camera image output from the imaging unit 101 to the image processing apparatus 200.

The reprojection unit 105 can acquire information about a change in the position and orientation of the HMD 100 based on the delay time of the individual world coordinate CG. The reprojection unit 109 can acquire information about a change in the relative position and orientation of the mobile object 400 with respect to the HMD 100 based on the delay times of the individual target coordinate CG. Therefore, the reprojection unit 105 and the reprojection unit 109 can accurately detect the processing delay due to the edge rendering and the processing delay due to the cloud rendering. In addition, the reprojection unit 105 and the reprojection unit 109 can perform appropriate reprojection processing on the CG following the mobile object 400, which moves independently of the HMD 100, by separately performing the reprojection processing for the individual CG.

According to Embodiment 2 described above, the image processing apparatus 200 can reduce the processing load by rendering some CG by the external server 800. While FIG. 8 illustrates the example in which the server 800 renders the world coordinate CG and the image processing apparatus 200 renders the target coordinate CG, the present invention is not limited to this example. The image processing apparatus 200 may cause the server 800 to perform the rendering processing of at least any of the world coordinate CG and the target coordinate CG.

In a case where there are a plurality of world coordinate CG and a plurality of target coordinate CG, the image processing apparatus 200 may switch between rendering by the image processing apparatus 200 and rendering by the server 800 for the individual CG. For example, the image processing apparatus 200 can reduce the processing load by causing the server 800 to render CG whose data size exceeds a threshold. In addition, the image processing apparatus 200 may switch whether or not to cause the server 800 to perform rendering of CG based on the frequency at which the user's gaze is directed toward the CG. For example, the image processing apparatus 200 can reduce the processing load by causing the server 800 to perform rendering of CG when the frequency at which the user's gaze is directed toward the CG is lower than a threshold within a predetermined time period. As described above, the processing load on the image processing apparatus 200 can be reduced by causing the server 800 to perform the rendering processing of some of the CG.

### Embodiment 3

In Embodiment 3, in view of occlusion, a mixed reality image is generated by accurately reflecting the relationship between the depth of an object in the real space in a camera image and the depth of CG to be superimposed. By accurately reflecting the relationship between the depth of the object in the real space and the depth of the CG, the HMD 100 can provide a realistic experience in the mixed reality space.

The HMD 100 generates a depth map from a camera image to accurately reflect the occlusion. In the example described in Embodiment 1, the data of the CG image generated by the rendering processing by the image processing apparatus 200 is RGBA data to which ID information is assigned. In Embodiment 3, the image processing apparatus 200 outputs RGBAD (D represents depth information) data to which ID information is assigned as the data of the CG image. The HMD 100 can generate a mixed reality image in view of occlusion by combining a camera image and a CG image by using depth information.

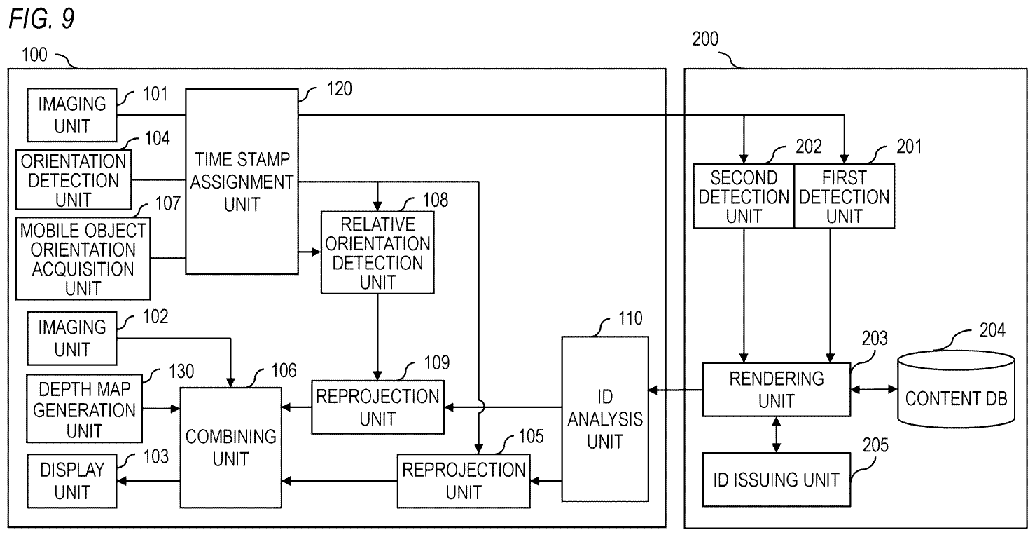

FIG. 9 is a block diagram illustrating an HMD 100 and an image processing apparatus 200 according to Embodiment 3. In addition to the configuration described with reference to FIG. 5, the HMD 100 includes a depth map generation unit 130. The same reference numerals are given to the same components as those in FIG. 5, and detailed description thereof will be omitted. Note that some of the functions of the HMD 100 illustrated in FIG. 9 may be implemented by the image processing apparatus 200. A part of the image processing apparatus 200 may be implemented by the HMD 100.

The depth map generation unit 130 generates a depth map of real space in a direction in which the HMD 100 is facing. Examples of the method for generating the depth map include a distance measuring method using a stereo camera and a method using a time of flight (TOF) sensor. In the following description, an imaging unit 102 is a stereo camera. The depth map generation unit 130 generates a depth map from a stereo camera image captured by the imaging unit 102.

The camera image captured by the imaging unit 102 is input to a combining unit 106 as image data including RGB color channels and a D channel indicating depth information on a pixel basis. The D channel is depth information expressed by, for example, 16 bits. The depth of each pixel is represented such that the smaller the numerical value indicated in the D channel is, the nearer (the closer to the HMD 100) the pixel is located, and the larger the numerical value indicated in the D channel is, the deeper (the farther from the HMD 100) the pixel is located.

Rendering processing performed by the image processing apparatus 200 will be described. An imaging unit 101 may be any device capable of acquiring depth information about the real space, and is a stereo camera in the present embodiment. Based on the data of the CG read from a content DB 204, a rendering unit 203 generates depth information for each pixel of the CG with reference to first coordinates and second coordinates detected from the stereo camera image captured by the imaging unit 101. With the depth information in the CG data, the rendering unit 203 can express, by a numerical value, the position of the CG data to be placed in the three-dimensional real space. The rendering unit 203 stores the depth information expressed by the numerical value in the D channel. That is, the D channel stores the value indicating the depth information for each pixel in which the CG is present. In addition to the D channel, the CG image data includes RGB channels as luminance information and an A channel as transparency information. As described above, in Embodiment 3, the rendering unit 203 generates CG image data including the D channel in addition to the RGBA channels.

An ID issuing unit 205 issues ID=1 to the world coordinate CG and issues ID=2 to the target coordinate CG. The rendering unit 203 assigns an ID for each pixel by replacing a predetermined bit of the A channel with ID information. The rendering unit 203 outputs the RGBAD data to which the ID information has been assigned to an ID analysis unit 110 of the HMD 100.

The processing performed by the ID analysis unit 110, a reprojection unit 105, and a reprojection unit 109 of the HMD 100 is the same as that in Embodiment 1.

That is, the ID analysis unit 110 separates the CG image by ID embedded in each pixel. The reprojection unit 105 performs reprojection processing on the world coordinate CG corresponding to ID=1 based on a change in the position and orientation of the HMD 100 during the rendering processing. The reprojection unit 109 performs reprojection processing on the target coordinate CG corresponding to ID=2 based on a change in the relative position and orientation of the mobile object 400 with respect to the HMD 100 during the rendering processing.

Processing performed by the combining unit 106 in Embodiment 3 will be described. The combining unit 106 combines the camera image of the real space captured by the imaging unit 102, the world coordinate CG image on which the reprojection processing has been performed by the reprojection unit 105, and the target coordinate CG image on which the reprojection processing has been performed by the reprojection unit 109.

The combining unit 106 compares the values of the D channels on a pixel basis, and performs the combining processing such that the pixel having the smallest value is placed at the foreground. The HMD 100 can generate a mixed reality image in view of occlusion by combining the CG image and the camera image by using depth information even with CG following the mobile object 400 that moves independently of the HMD 100.

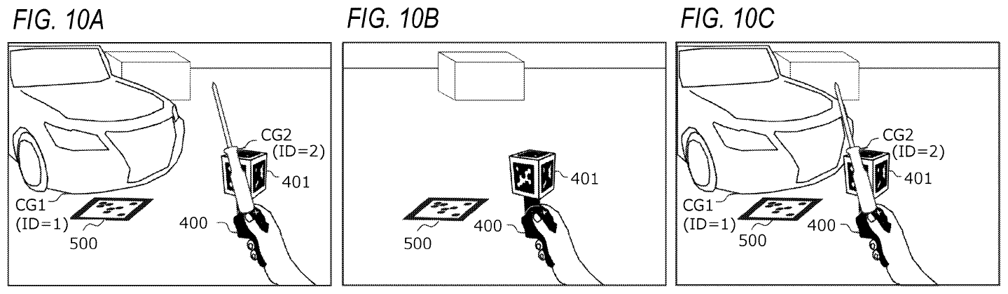

Effects of Embodiment 3 will be described with reference to FIGS. 10A to 10C. FIG. 10A illustrates a mixed reality image displayed on a display unit 103 of the HMD 100. The user using the HMD 100 moves the right hand to the left without moving the head from the state illustrated in FIG. 10A.

FIG. 10B illustrates a camera image captured by the imaging unit 102 after the user has moved the right hand to the left. Since the relative position and orientation of the mobile object 400 with respect to the HMD 100 has changed, the reprojection unit 109 performs the reprojection processing on CG 2 of a screwdriver. When the CG 2 of the screwdriver is moved to the left to follow the movement of the right hand, a part of the CG 2 of the screwdriver overlaps the area of CG 1 of a vehicle. When the CG 1 and the CG 2 overlap each other, the combining unit 106 uses the values of the D channels to determine which CG are to be displayed in front.

When the depth information in the D channel of the CG 2 of the screwdriver is smaller than the depth information in the D channel of the CG 1 of the vehicle, the combining unit 106 generates a combined image such that the CG 2 is rendered in front. FIG. 10C illustrates a mixed reality image combined such that the CG 2 of the screwdriver is rendered in front of the CG 1 of the vehicle. With the combination in which the CG 2 of the screwdriver is in front of the CG 1 of the vehicle, the mixed reality image that appears without any sense of discomfort has been generated.

Furthermore, the combining unit 106 combines the camera image and the CG images in view of depth information. The combining unit 106 uses the depth information about the CG image of the CG 1 of the vehicle, the depth information about the CG image of the CG 2 of the screwdriver, and the depth information (depth map) about the camera image to combine each CG image and the camera image.

Each of the camera image, the CG image of the CG 1, and the CG image of the CG 2 retains its depth information on a pixel basis. The combining unit 106 can maintain an accurate front-to-back relationship by comparing the respective pieces of depth information about the camera image, the CG image of the CG 1, and the CG image of the CG 2 on a pixel basis. For example, in FIG. 10A, the camera image of the right hand is present in front of the CG 1, and when the right hand overlaps the CG 1 of the vehicle, the combining unit 106 can generate a combined image such that the right hand is rendered in front of the CG1 of the vehicle.

Embodiment 3 is also applicable to a VR system. In the VR system, the combining unit 106 uses the depth information about the CG image of the CG 1 of the vehicle and the depth information about the CG image of the CG 2 of the screwdriver to combine the CG images. The combining unit 106 can generate a virtual reality image that appears without any sense of discomfort in view of occlusion.

According to Embodiment 3, the HMD 100 can perform the CG reprojection processing in view of occlusion by generating a combined image based on depth information. Further, as in Embodiments 1 and 2, the HMD 100 can cause the target coordinate CG corresponding to the mobile object 400, which moves independently of the HMD 100, to follow the mobile object 400. As a result, the user can appreciate a mixed reality image that appears without any sense of discomfort. Although the embodiments of the present invention have been described in detail, the present invention is not limited to these embodiments, and includes configurations obtained by modifications and changes without departing from the gist of the present invention. Further, the present invention includes configurations obtained by appropriately combining the embodiments.

Note that the functional units (FIGS. 2, 5, 8, and 9) of the image processing apparatus and the HMD according to Embodiments 1 to 3 may be or may not be individual hardware. Functions of two or more functional units may be implemented by common hardware. Each of a plurality of functions of one functional unit may be implemented by individual hardware. Two or more functions of one functional unit may be implemented by common hardware. Each functional unit may be implemented by hardware or may not be implemented by hardware. For example, an apparatus may include a processor and a memory in which a control program is stored. The functions of at least some of the functional units included in the apparatus may be implemented by the processor executing the control program read from the memory.

According to the present invention, it is possible to provide an image processing apparatus that achieves reprojection processing without causing a sense of discomfort for the CG following a mobile object that moves independently of an HMD.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-218311, filed on Dec. 25, 2023, which is hereby incorporated by reference herein in its entirety.

What is claimed is:

1. An image processing apparatus comprising one or more processors and/or circuitry configured to:
perform first acquisition processing to acquire information about position and orientation of a display apparatus;
perform second acquisition processing to acquire information about relative position and orientation of a mobile object, which moves independently of the display apparatus, with respect to the display apparatus;
perform rendering processing to render a first object arranged in real space, which serves as a field of view of a user, based on position and orientation of the display apparatus and to render a second object arranged in the real space based on position and orientation of the mobile object; and
perform reprojection processing on the first object based on a change in position and orientation of the display apparatus during the rendering processing and perform reprojection processing on the second object based on a change in relative position and orientation of the mobile object with respect to the display apparatus during the rendering processing.

2. The image processing apparatus according to claim 1, wherein the one or more processors and/or the circuitry is further configured to perform display control processing to perform control so as to combine a first image obtained by performing reprojection processing on the first object and a second image obtained by performing reprojection processing on the second object to be displayed on the display apparatus.

3. The image processing apparatus according to claim 2, wherein, in the display control processing, depth information about the first image and depth information about the second image are used to combine the first image and the second image.

4. The image processing apparatus according to claim 1, wherein the one or more processors and/or the circuitry is further configured to perform display control processing to perform control so as to combine a first image obtained by performing reprojection processing on the first object, a second image obtained by performing reprojection processing on the second object, and a captured image of the real space captured by an image capturing apparatus after the rendering processing to be displayed on the display apparatus.

5. The image processing apparatus according to claim 4, wherein, in the display control processing, depth information about the first image, depth information about the second image, and depth information about the captured image are used to combine the first image, the second image, and the captured image.

6. The image processing apparatus according to claim 1, wherein in the rendering processing, an ID that is mutually identifiable is assigned to each of the first object and the second object, and in the reprojection processing, the first object and the second object are identified based on the ID.

7. The image processing apparatus according to claim 6, wherein, in the rendering processing, each ID is stored in any of a plurality of channels included in each of the first object data and the second object data.

8. The image processing apparatus according to claim 7, wherein, in the rendering processing, the ID is stored in a part of a channel including information about transmittance among the plurality of channels.

9. The image processing apparatus according to claim 1, wherein, in the rendering processing, an external apparatus is caused to perform the rendering processing on at least any of the first object and the second object.

10. A control method for an image processing apparatus, the control method comprising steps of:
acquiring information about position and orientation of a display apparatus;
acquiring information about relative position and orientation of a mobile object, which moves independently of the display apparatus, with respect to the display apparatus;
performing rendering processing to render a first object arranged in real space, which serves as a field of view of a user, based on position and orientation of the display apparatus and to render a second object arranged in the real space based on position and orientation of the mobile object; and
performing reprojection processing on the first object based on a change in position and orientation of the display apparatus during the rendering processing and performing reprojection processing on the second object based on a change in relative position and orientation of the mobile object with respect to the display apparatus during the rendering processing.

11. A non-transitory computer-readable medium that stores a program, wherein the program causes a computer to execute a control method for an image processing apparatus, the control method comprising steps of:
acquiring information about position and orientation of a display apparatus;
acquiring information about relative position and orientation of a mobile object, which moves independently of the display apparatus, with respect to the display apparatus;
performing rendering processing to render a first object arranged in real space, which serves as a field of view of a user, based on position and orientation of the display apparatus and to render a second object arranged in the real space based on position and orientation of the mobile object; and
performing reprojection processing on the first object based on a change in position and orientation of the display apparatus during the rendering processing and performing reprojection processing on the second object based on a change in relative position and orientation of the mobile object with respect to the display apparatus during the rendering processing.
